(19) United States
(12) Patent Application Publication
(10) Pub. No.: US 2017/0046040 A1
(43) Pub. Date: Feb. 16, 2017

(54) TERMINAL DEVICE AND SCREEN CONTENT ENLARGING METHOD

(71) Applicants: HISENSE MOBILE COMMUNICATIONS TECHNOLOGY CO.,LTD., Shandong (CN); HISENSE USA CORPORATION, Suwanee, GA (US); HISENSE INTERNATIONAL CO.,LTD., Shandong (CN)

(72) Inventor: Lei Wang, Shandong (CN)

(21) Appl. No.: 15/082,273

(22) Filed: Mar. 28, 2016

(30) Foreign Application Priority Data
Aug. 14, 2015 (CN) 201510501438.2

(51) Int. Cl. G06F 3/0488; G06F 3/0481; G06F 3/0484

(52) U.S. Cl. CPC G06F 3/0488; G06F 3/04845; G06F 3/04817; H04W 88/02

(57) ABSTRACT

The embodiment of the present disclosure provides a screen content enlarging method and a terminal device and relates to the field of mobile terminals. The method comprises the following operations: when detects a touch point in a floating icon region in a user interface of the terminal device, a terminal device records position information of the touch point in the user interface, wherein the floating ion is in a movable state; selects a to-be-enlarged display region corresponding to the touch point from the user interface according to the position information; and enlarges original display contents in the to-be-enlarged display region in accordance with a predetermined enlarging scale and displays the enlarged contents in a screen content enlarging window.

### CROSS-REFERENCE TO RELATED APPLICATIONS

This application claims the priority to Chinese Patent Application No. 201510501438.2, filed on Aug. 14, 2015, the content of which is hereby incorporated by reference in its entirety.

### FIELD

The present disclosure relates to the field of mobile terminals, and particularly to a terminal device and a screen content enlarging method.

### BACKGROUND

At present, in order to facilitate people with impaired vision to more easily read screen characters and distinguish picture resources, most mobile terminals which are available in the market nowadays have a screen content enlarging function, such that users can enlarge screen contents according to personal demands.

### SUMMARY

The embodiment of the present disclosure further provides a terminal device including a touch screen and a processing module, wherein:

the touch screen is configured to display contents to be displayed by the terminal device and to sense a slide of a touch object at a touch point on the touch screen, to receive an input of the touch object on the touch point on the device screen, to convert the input into a response signal and to transmit the response signal to the processing module; and

the processing module is configured to, when the processing module detects a touch point in a floating icon region in a user interface of the terminal device, record position information of the touch point in the user interface, wherein the floating ion is in a movable state; select a to-be-enlarged display region corresponding to the touch point from the user interface according to the position information; and enlarge original display contents in the to-be-enlarged display region in accordance with a predetermined enlarging scale and display the enlarged contents in a screen content enlarging window.

The embodiment of the present disclosure further provides a terminal device including one or more processors and a memory, wherein one or more computer readable program codes are stored in the memory, and the one or more processors configured to execute the one or more computer readable program codes to perform: when the terminal device detects a touch point in a floating icon region in a user interface of the terminal device, recording position information of the touch point in the user interface, wherein the floating ion is in a movable state; selecting a to-be-enlarged display region corresponding to the touch point from the user interface according to the position information; and enlarging original display contents in the to-be-enlarged display region in accordance with a predetermined enlarging scale and displaying the enlarged contents in a screen content enlarging window.

The embodiment of the present disclosure provides a screen content enlarging method, including:

when a terminal device detects a touch point in a floating icon region in a user interface of the terminal device, recording position information of the touch point in the user interface, wherein the floating ion is in a movable state;

selecting a to-be-enlarged display region corresponding to the touch point from the user interface according to the position information; and

enlarging original display contents in the to-be-enlarged display region in accordance with a predetermined enlarging scale and displaying the enlarged contents in a screen content enlarging window.

### BRIEF DESCRIPTION OF THE DRAWINGS

In order to make the technical solutions in the embodiments of the disclosure or the prior art more apparent, the drawings to which the embodiments or the prior art are described with reference will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a schematic flow chart of a screen content enlarging method according to an embodiment of the present disclosure;

FIG. 2 is a schematic view of screen content enlargement in a user interface of a terminal device according to an embodiment of the present disclosure;

FIG. 3 is a regional schematic view of a to-be-enlarged display region according to an embodiment of the present disclosure;

FIG. 4 is a regional schematic view of a to-be-enlarged display region according to an embodiment of the present disclosure;

FIG. 5 is a regional schematic view of a to-be-enlarged display region according to an embodiment of the present disclosure;

FIG. 6 is a schematic diagram of a terminal device according to an embodiment of the present disclosure;

FIG. 7 is a structural schematic diagram of a terminal device according to an embodiment of the present disclosure.

### DETAILED DESCRIPTION OF THE EMBODIMENTS

The technical solution in the embodiments of the present disclosure will be clearly and completely described below with reference to the drawings in the embodiments of the present disclosure. Obviously, the embodiments to be described are just partial embodiments of the present disclosure instead of all embodiments. Based upon the embodiments here of the invention, all of other embodiments derived by those ordinarily skilled in the art without any inventive effort shall come into the scope of the invention.

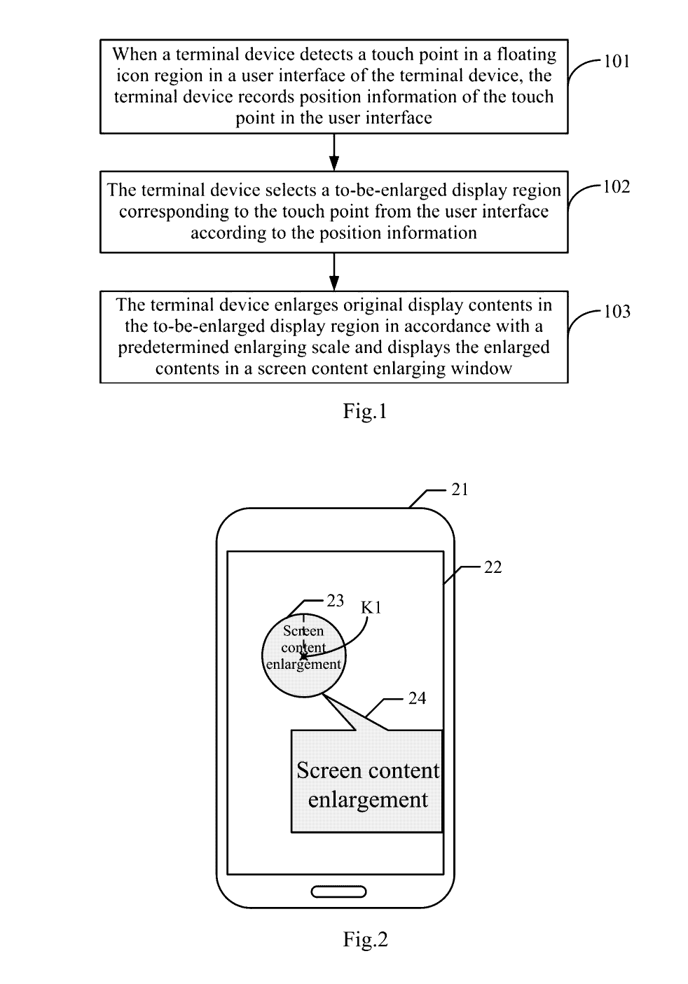

The embodiment of the present disclosure provides a screen content enlarging method. As illustrated in FIG. 1, the method includes the following operations:

Operation 101: when a terminal device detects a touch point in a floating icon region in a user interface of the terminal device, the terminal device records position information of the touch point in the user interface.

The terminal device in this embodiment of the present disclosure can be an electronic device with a touch screen, such as a smart phone, a tablet computer or a PDA (Personal Digital Assistant).

The floating icon in this embodiment is preinstalled in the user interface of the terminal device, and the floating icon can be used for monitoring user operation so as to determine a screen content region which is wanted to be enlarged by a user, wherein the floating icon in this embodiment is in a movable state, i.e., the user can move the floating icon to any region in the user interface of the terminal device. The position information of the above-mentioned touch point in the user interface includes coordinate information of the touch point in the user interface.

Before operation 101, the terminal device can display the floating icon on one side of the user interface of the terminal device by invoking icon information corresponding to the floating icon. In order to distinguish the floating icon from other application icons, the floating icon can be a suspended semitransparent icon button.

Operation 102: the terminal device selects a to-be-enlarged display region corresponding to the touch point from the user interface according to the position information.

Operation 103: the terminal device enlarges original display contents in the to-be-enlarged display region in accordance with a predetermined enlarging scale, and displays the enlarged contents in a screen content enlarging window.

Exemplarily, as illustrated in FIG. 2, when a to-be-enlarged display region 23 corresponding to a touch point K1 detected by a terminal device 21 in a user interface 22 is a circular region and the touch point K1 is a circle center of the to-be-enlarged display region 23, the terminal device enlarges screen contents displayed in the to-be-enlarged display region 23 and displays the enlarged contents in a screen content enlarging window 24.

Here the above-mentioned circular to-be-enlarged display region is just exemplary. The to-be-enlarged display region in actual application can be a circular region, a square region or a region in any shape. The present disclosure does not make a limitation thereto. The terminal device can set freely according to user demands.

Exemplarily, when the above-mentioned to-be-enlarged display region is a circular region, a method of determining the to-be-enlarged display region corresponding to the touch point includes the following operations:

When the terminal device sets the position of the touch point recorded in operation 101 in the user interface as a circle center of the to-be-enlarged display region, the terminal device uses a circular region with a circle center being the position of the touch point in the user interface and within a preset region radius as the to-be-enlarged display region corresponding to the touch point;

Or,

When the terminal device does not set the position of the touch point recorded in operation 101 in the user interface as a circle center of the to-be-enlarged display region, the terminal device determines a central point of the to-be-enlarged display region according to the position information of the touch point in the user interface and a preset region radius, and then uses a circular region with a circle center being the central point and within the preset region radius in the user interface as the to-be-enlarged display region corresponding to the touch point.

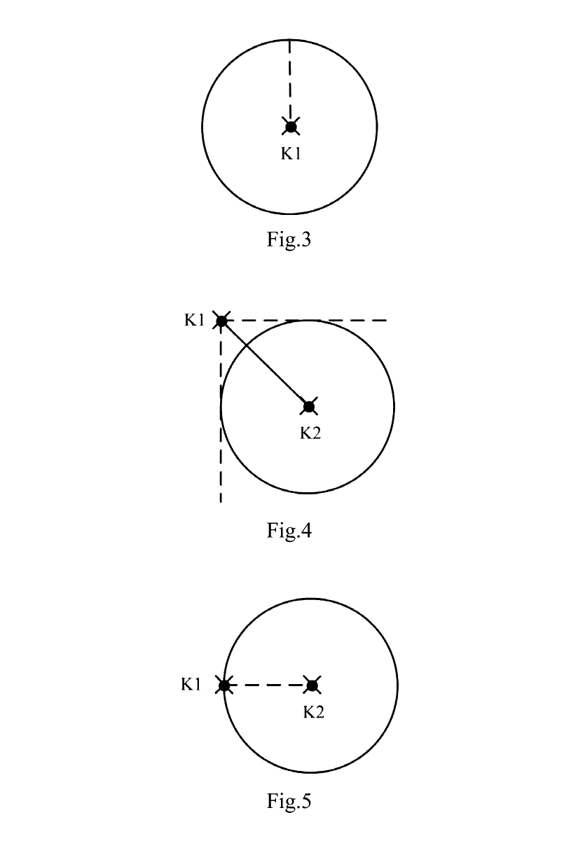

For example, when a coordinate of the touch point K1 recorded by the terminal device in operation 101 is (X1, Y1) and the preset region radius is R, if the touch point K1 is set as a circle center of the to-be-enlarged display region corresponding to the touch point K1, a regional schematic view of the to-be-enlarged display region is as illustrated in FIG. 3; if the terminal device uses the touch point K1 as an intersecting point of two perpendicular tangent lines of the to-be-enlarged display region corresponding to the touch point K1 (as illustrated in FIG. 4), a coordinate of a central point K2 of the to-be-enlarged display region is (X1±R, Y1±R) and the central point K2 is used as a circle center, a regional schematic view of the corresponding to-be-enlarged display region is as illustrated in FIG. 4; and if the terminal device uses the touch point K1 as a regional edge point of the to-be-enlarged display region, a coordinate of the central point K2 of the to-be-enlarged display region is (X1+R, Y1) and the central point K2 is used as a circle center, a regional schematic view of the corresponding to-be-enlarged display region is as illustrated in FIG. 5.

Exemplarily, an image displayed in the user interface of the terminal device consists of a great amount of discrete points. All points in the image can be described by adopting a two-dimensional planar rectangular coordinate system. For example, if the image in the to-be-enlarged display region in the user interface is enlarged by H1 and H2 times in an x-axis direction and a y-axis direction respectively, x-axis and y-axis coordinates of all points in the image will be respectively enlarged by H1 and H2 times, i.e.,

x=H1*x0

y=H2*y0

Through the above-mentioned process, all points in the image are enlarged, thus realizing the enlargement of the image.

After operation 103, the method further includes the following operations:

Operation 104: when the terminal device detects that the touch point and the floating icon move simultaneously, the terminal device enlarges the original display contents in the to-be-enlarged display region currently corresponding to the touch point in accordance with the predetermined enlarging scale and displays the enlarged contents in the screen content enlarging window in real time.

Exemplarily, when the terminal device detects that the touch point and the floating icon move simultaneously, i.e., the user drags the floating icon to move through touch operation, in the moving process, the terminal device may record the position information of the touch point in the user interface in real time, determine the to-be-enlarged display region currently corresponding to the touch point according to the position information after each time that the position information of the touch point in the user interface is recorded, enlarge the original display contents in the to-be-enlarged display region in accordance with the preset enlarging scale and display the enlarged contents in the screen content enlarging window. Thus, in the moving process of the touch point and the floating icon, the screen content enlarging window may be always displayed, following a moving trajectory of the touch point.

In addition, when the terminal device detects that the touch point and the floating icon move simultaneously, the terminal device may calculate a region range of the to-be-enlarged display region corresponding to the floating icon to guarantee that the to-be-enlarged display region can be completely displayed on a terminal screen. For example, when the user moves the floating icon to get close to the boundary of the screen, the to-be-enlarged display region according to a default position relationship can only select partial screen contents. At this moment, the terminal device can select the contents by shifting the to-be-enlarged display region corresponding to the floating icon towards a direction opposite to the boundary of the screen. In addition, in order to prevent the floating icon from being overlapped with the screen content enlarging window, the terminal device may calculate the region positions of the floating icon and the screen content enlarging window in real time to guarantee that the user can simultaneously observe the floating icon and the screen content enlarging window. For example, when the floating icon and the screen content enlarging window are overlapped, the terminal device can move the screen content enlarging window to other regions to prevent the floating icon and the screen content enlarging window from being overlapped.

Exemplarily, in order to provide better user experience to the user, before operation 103, i.e., while displaying the screen content enlarging window in the user interface, in order to prevent the floating icon from affecting the user to view the screen contents displayed in the screen content enlarging window, the terminal device can select to hide or remove the floating icon displayed in the user interface. However, it should be noted that, when the terminal device does not detect the touch point in the floating icon region, i.e., the user stops performing touch operation to the terminal device, the terminal device needs to remove the screen content enlarging window and redisplay the floating icon at an initial position in the user interface or at a predetermined position in the user interface to facilitate the subsequent continuous use by the user.

The screen content enlarging method according to an embodiment of the present disclosure includes the following operations: when detecting a touch point in a floating icon region in a user interface of the terminal device, a terminal device records position information of the touch point in the user interface, wherein the floating icon is in a movable state; then selects a to-be-enlarged display region corresponding to the touch point from the user interface according to the position information; and finally, enlarges original display contents in the to-be-enlarged display region in accordance with a predetermined enlarging scale and displays the enlarged contents in a screen content enlarging window. Thus, by selecting the to-be-enlarged display region through the floating icon, the enlargement of local screen contents can be realized; and in addition, since the floating icon is in the movable state, the user can move the floating icon to a region in which the screen contents need to be enlarged, so that the user can freely enlarge the display contents in any region of the user interface and the screen content browsing efficiency of the user is improved.

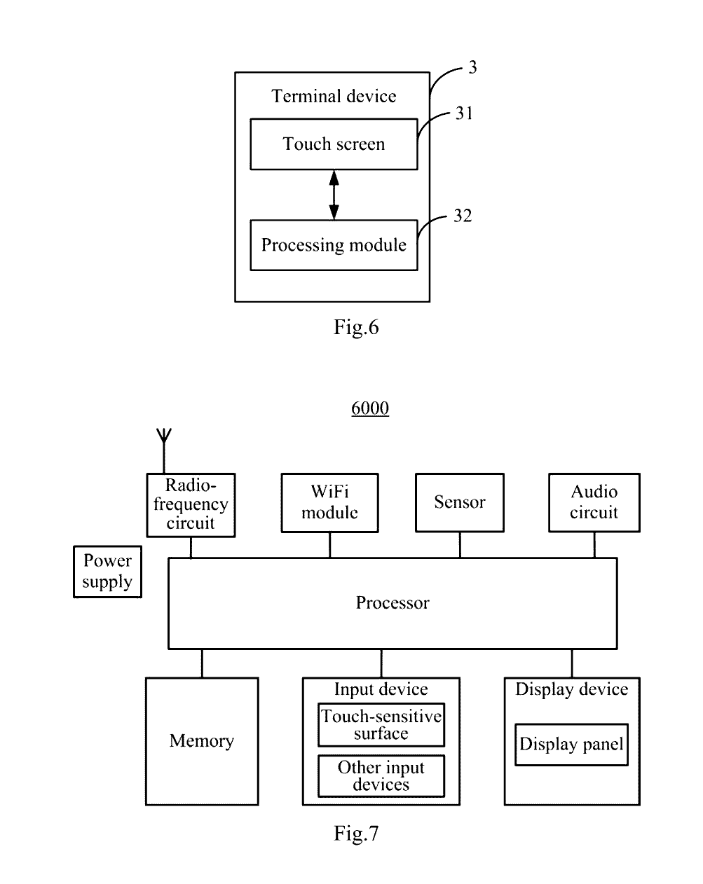

The embodiment of the present disclosure further provides a terminal device. As illustrated in FIG. 6, the terminal device 3 comprises a touch screen 31 and a processing module 32, wherein:

The touch screen 31 is also called as a touch panel and is configured to display contents to be displayed by the terminal device and to sense a slide of a touch object at a touch point on the touch screen 31, to receive an input of the touch object on the touch point on the device screen 31, to collect user touch operation thereon or close thereto (such as operation performed by the user on or close to the touch screen 31 by using any suitable objects or accessories such as a finger and a stylus), to drive a corresponding connected processing device according to a preset program, to convert the input into a response signal and to transmit the response signal to the processing module 32; and

The processing module 32 is configured to, when a touch point in a floating icon region in a user interface of the terminal device is detected, record position information of the touch point in the user interface, wherein the floating ion is in a movable state; select a to-be-enlarged display region corresponding to the touch point from the user interface according to the position information; and enlarge original display contents in the to-be-enlarged display region in accordance with a predetermined enlarging scale and display the enlarged contents in a screen content enlarging window.

Alternatively, the processing module 32 is further configured to:

When the processing module 32 detects that the touch point and the floating icon move simultaneously, enlarge the original display contents in the to-be-enlarged display region currently corresponding to the touch point in accordance with the predetermined enlarging scale and display the enlarged contents in the screen content enlarging window in real time.

Alternatively, the processing module 32 selecting the to-be-enlarged display region corresponding to the touch point from the user interface according to the position information is configured to:

Determine a central point of the to-be-enlarged display region according to the position information and a preset region radius; and

Determine a circular region with a circle center being the central point and within the preset region radius in the user interface as the to-be-enlarged display region corresponding to the touch point.

Alternatively, the processing module 32 selecting the to-be-enlarged display region corresponding to the touch point from the user interface according to the position information is configured to:

Determining a circular region with a circle center being the position of the touch point in the user interface and within the preset region radius as the to-be-enlarged display region corresponding to the touch point.

Alternatively, the processing module 32 is further configured to:

Hide or remove the floating icon; and

The processing module 32 is further configured to, when the processing module 32 does not detect the touch point in the floating icon region, remove the screen content enlarging window and redisplay the floating icon at an initial position in the user interface or at a predetermined position in the user interface.

The terminal device according to an embodiment of the present disclosure executes the following operations: when detecting a touch point in a floating icon region in a user interface of the terminal device, the terminal device records position information of the touch point in the user interface, wherein the floating icon is in a movable state; then selects a to-be-enlarged display region corresponding to the touch point from the user interface according to the position information; and finally, enlarges original display contents in the to-be-enlarged display region in accordance with a predetermined enlarging scale and displays the enlarged contents in a screen content enlarging window. Thus, by selecting the to-be-enlarged display region through the floating icon, the enlargement of local screen contents can be realized; and in addition, since the floating icon is in the movable state, the user can move the floating icon to a region in which the screen contents need to be enlarged, so that the user can freely enlarge the display contents in any region of the user interface and the screen content browsing efficiency of the user is improved.

Based on the same concept as the screen content enlarging method, the embodiment of the present disclosure further provides a terminal device, which comprises one or more processors; and a memory, wherein one or more computer readable program codes are stored in the memory, and the one or more processors are configured to execute the one or more computer readable program codes to perform: when the terminal device detects a touch point in a floating icon region in a user interface of the terminal device, recording position information of the touch point in the user interface, wherein the floating ion is in a movable state; selecting a to-be-enlarged display region corresponding to the touch point from the user interface according to the position information; and enlarging original display contents in the to-be-enlarged display region in accordance with a predetermined enlarging scale and displaying the enlarged contents in a screen content enlarging window.

The terminal device 6000 in this embodiment of the present disclosure can be any one of various handheld devices (such as mobile phones, tablet computers and PDAs, etc.), which can include a processor with one or more processing cores, a radio-frequency circuit, a memory with one or more computer readable storage mediums, an input device, a display device, a sensor, an audio circuit, a WiFi module, a power supply and the like. One skilled in the art can understand that the structure of the terminal device 6000 in this embodiment of the present disclosure does not constitute a limitation and can comprise more or fewer components, or combinations of certain components or different component configurations.

The radio frequency circuit can be configured to receive and transmit a signal in the course of receiving and transmitting information or in communication, particularly by transferring downlink information received from a base station to the one or more processors for processing upon reception of the downlink information; and also transmitting uplink data to the base station. Typically the radio frequency circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the radio frequency circuit can further communicate with a network and another device through wireless communication. The wireless communication can comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

The memory can be configured to store software programs and modules, and the processor is configured to run the software programs and modules stored in the memory to thereby perform various function applications and data processing. The memory can generally include a program storage area and a data storage area, where an operating system, applications required for at least one function (e.g., an audio playing function, an image playing function, etc.), etc., can be stored in the program storage area; and data created for use of the terminal device 6000 (e.g., audio data, an address book etc.), etc., can be stored in the data storage area. Moreover the memory can include a high-speed random access memory and can further include a nonvolatile memory, e.g., at least one magnetic-disk memory device, flash memory device, or another volatile solid memory device. Correspondingly the memory can further include a memory controller configured to provide an access to the memory for the processor and the input device.

The input device can be configured to receive input digital or character information and to generate a keyboard, mouse, joystick, optical or track ball signal input related to user setting and function control. Particularly the input device can include a touch sensitive surface and another input device. The touch sensitive surface, also referred to as a touch display screen or a touch control pad, can be configured to collect a touch operation by a user thereon or in proximity thereto (e.g., an operation by the user on or in proximity to the touch sensitive surface using his or her finger, a stylus or any other appropriate object or attachment) and to drive a corresponding connected device by preset program. Optionally the touch sensitive surface can include two components which are a touch detection device and a touch controller, where the touch detection device detects the position of touching by the user and detects a signal as a result of the touch operation and transfers the signal to the touch controller; and the touch controller receives the touch signal from the touch detection device and converts it into coordinates of a touch point and further transfers them to the processor and can receive and execute a command sent by the processor. Moreover the touch sensitive surface can be embodied in various types of resistive, capacitive, infrared, surface sound wave and other types. The input device can further include another input device in addition to the touch sensitive surface. Particularly the other input device can include but will not be limited to one or more of a physical keyboard, functional buttons (e.g., volume control buttons, a power-on or-off button, etc.), a track ball, a mouse, a joystick, etc.

The display device can be configured to display information input by the user or information provided to the user, and various graphic user interfaces of the terminal device 6000, where these graphic user interfaces can be composed of graphics, texts, icons, videos and any combination thereof. The display device can include a display panel which can be optionally configured in the form of a Liquid Crystal Display (LCD), an Organic Light-Emitting Diode (OLED) display, etc. Furthermore the touch sensitive surface can overlie the display panel, and the touch sensitive surface, upon detection of the touch operation thereon or in proximity thereto, transfers it to the processor to determine the type of the touch event, and thereafter the processor provides a corresponding visual output on the display panel according to the type of the touch event. Although the touch sensitive surface and the display panel are embodied in this embodiment as two separate components to perform the input and output functions, the touch sensitive surface and the display panel can be integrated to perform the input and output functions in some embodiments.

As illustrated in FIG. 7, the terminal device 6000 in this embodiment of the present disclosure further can include at least one sensor, e.g., an optical sensor, a motion sensor, and other sensors. Particularly the optical sensor can include an ambient optical sensor and a proximity sensor, where the ambient optical sensor can adjust the brightness of the display panel according to the luminosity of ambient light rays, and the proximity sensor can power off the display panel and/or a backlight when the terminal device 6000 moves in proximity to an ear. A gravity acceleration sensor which is a motion sensor can detect the magnitudes of accelerations in respective directions (typically three axes), and can detect the magnitude and the direction of gravity when the sensor is stationary and can be configured to perform applications of identifying the posture of a handset (e.g., switching between landscape and portrait modes, relevant games, calibration of the posture of a magnetometer, etc.), a relevant function of identifying vibration (e.g., a pedometer, a knock, etc.), etc.; and the terminal device 6000 can be further configured with a gyroscope, a barometer, a hygrometer, a thermometer, an infrared sensor and other sensors, and a repeated description of these components will be omitted here.

The audio circuit, a speaker and a transducer can provide an audio interface between the user and the terminal device 6000. The audio circuit can convert received audio data into an electric signal and transmit the electric signal to the speaker, which is converted by the speaker into an audio signal for output; and on the other hand, the transducer converts a collected audio signal into an electric signal which is received by the audio circuit and then converted into audio data, and the audio data is further output to the processor for processing and then transmitted to another apparatus through the radio frequency circuit, for example, or the audio data is output to the memory for further processing. The audio circuit may further include an earphone jack for communication between a peripheral earphone and the terminal device 6000.

The WiFi falls into the category of short-range wireless transmission technologies, and the terminal device 6000 can assist the user in receiving and transmitting an e-mail, browsing a webpage, accessing streaming media, etc., through the WiFi module by which the user is provided with a wireless access to the broadband Internet. Although the WiFi module is illustrated in this embodiment, it can be appreciated that it may not be necessarily required for the terminal device 6000 but can be omitted as desired without departing from the scope of the disclosure.

The processor is a control component of the terminal device 6000, has the respective components connected by various interfaces and lines, and runs or executes the software programs and/or modules stored in the memory and invokes the data stored in the memory to perform the various functions of the terminal device 6000 and process the data to thereby manage and control the handset as a whole. Optionally the processor can include one or more processing cores; and preferably the processor can be integrated with an application processor and a modem processor, where the application processor generally handles the operating system, the user interfaces, the applications, etc., and the modem processor generally handles wireless communication. As can be appreciated, the modem processor above may not be integrated into the processor.

The terminal device 6000 further includes a power source (e.g., a battery) powering the respective components, and preferably the power source can be logically connected with the processor through a power management system to thereby perform charging and discharging management, power consumption management, etc., through the power management system. The power source can further include one or more direct current or alternating current power sources, recharging systems, power source failure detection circuits, power source transformers or inverters, power source status indicators, and any other components.

Although not illustrated, the terminal device 6000 can further include a webcam, a Bluetooth module, etc., and a repeated description thereof will be omitted here. In an embodiment, the display device of the terminal device 6000 is a touch screen display, and the terminal device 6000 further includes a memory in which one or more programs are stored and configured to be executed by the one or more processors. The above-mentioned one or more programs include commands used for performing the following operations:

When detecting a touch point in a floating icon region in a user interface of the terminal device, the terminal device records position information of the touch point in the user interface, wherein the floating ion is in a movable state; selects a to-be-enlarged display region corresponding to the touch point from the user interface according to the position information; and enlarges original display contents in the to-be-enlarged display region in accordance with a predetermined enlarging scale and displays the enlarged contents in a screen content enlarging window.

The present disclosure further provides a computer readable storage medium, in which one or more programs are stored, wherein the one or more programs are executed by one or more processors to perform the screen content enlarging method which includes the following operations: upon detecting a touch point in a floating icon region in a user interface of the terminal device, a terminal device records position information of the touch point in the user interface, wherein the floating ion is in a movable state; selects a to-be-enlarged display region corresponding to the touch point from the user interface according to the position information; and enlarges original display contents in the to-be-enlarged display region in accordance with a predetermined enlarging scale and displays the enlarged contents in a screen content enlarging window.

The computer readable storage medium can be a computer readable storage medium included in the memory of the above-mentioned embodiment, and can also be a separately existing computer readable storage medium which is not assembled in the device. One skilled in the art can clearly understood that, for the sake of convenience and simplicity in description, exemplary description is made only through the division of the above-mentioned function modules, and in actual application, the above-mentioned functions can be allocated to and accomplished by different function modules according to the needs, i.e., the internal structure of the device is divided into different function modules, so as to accomplish all or partial functions described above. For specific working processes of the device and modules described above, a reference can be made to the corresponding processes in the foresaid method embodiment, so a repeated description thereof will be omitted here.

In several embodiments according to the present application, it shall be understood that the device and method disclosed thereby can be realized by other methods. For example, the device embodiment described above is just exemplary. For example, the division of the modules is just division according to logic functions and other division methods can be adopted during actual realization. For example, a plurality of modules or components can be combined or integrated into another system, or some features can be ignored or are not executed. In addition, all function modules in each embodiment of the present application can be integrated in one processing module, and each module can also solely and physically exist. The above-mentioned integrated modules not only can be realized by means of hardware, but also can be realized by means of software function modules.

As described above, the above-mentioned embodiments are just used for describing instead of limiting the technical solutions of the present application; although the present application is described in detail by referring to the above-mentioned embodiments, one skilled in the art should understand that modifications can be made to the technical solutions recorded in the above-mentioned embodiments or equivalent replacements can be made to partial technical features therein; and however, such modifications or replacements shall not enable the essences of the corresponding technical solutions to depart from the spirit and the range of the technical solution of each embodiment.

1. A terminal device, the terminal device comprising a touch screen and a processing module, wherein:
the touch screen is configured to display contents to be displayed by the terminal device and to sense a slide of a touch object at a touch point on the touch screen, to receive an input of the touch object on the touch point on the device screen, to convert the input into a response signal and to transmit the response signal to the processing module; and
the processing module is configured to, when a touch point in a floating icon region in a user interface of the terminal device is detected, record position information of the touch point in the user interface, wherein the floating ion is in a movable state; select a to-be-enlarged display region corresponding to the touch point from the user interface according to the position information; and enlarge original display contents in the to-be-enlarged display region in accordance with a predetermined enlarging scale and display the enlarged contents in a screen content enlarging window.

2. The terminal device according to claim 1, wherein the processing module is further configured to:
when the processing module detects that the touch point and the floating icon move simultaneously, enlarge the original display contents in the to-be-enlarged display region currently corresponding to the touch point in accordance with the predetermined enlarging scale and display the enlarged contents in the screen content enlarging window in real time.

3. The terminal device according to claim 1, wherein the processing module selecting the to-be-enlarged display region corresponding to the touch point from the user interface according to the position information is configured to:
determine a central point of the to-be-enlarged display region according to the position information and a preset region radius; and
determine a circular region with a circle center being the central point and within the preset region radius in the user interface as the to-be-enlarged display region corresponding to the touch point.

4. The terminal device according to claim 2, wherein the processing module selecting the to-be-enlarged display region corresponding to the touch point from the user interface according to the position information is configured to:
determine a central point of the to-be-enlarged display region according to the position information and a preset region radius; and
determine a circular region with a circle center being the central point and within the preset region radius in the user interface as the to-be-enlarged display region corresponding to the touch point.

5. The terminal device according to claim 1, wherein the processing module selecting the to-be-enlarged display region corresponding to the touch point from the user interface according to the position information is configured to:
determine a circular region with a circle center being the position of the touch point in the user interface and within a preset region radius as the to-be-enlarged display region corresponding to the touch point.

6. The terminal device according to claim 1, wherein the processing module is further configured to:
hide or remove the floating icon; and
the processing module is further configured to, when the processing module does not detect the touch point in the floating icon region, remove the screen content enlarging window and redisplay the floating icon at an initial position in the user interface or at a predetermined position in the user interface.

7. A terminal device, comprising:
one or more processors; and
a memory, wherein:
one or more computer readable program codes are stored in the memory, and the one or more processors are configured to execute the one or more computer readable program codes to perform:
when the terminal device detects a touch point in a floating icon region in a user interface of the terminal device, recording position information of the touch point in the user interface, wherein the floating ion is in a movable state;
selecting a to-be-enlarged display region corresponding to the touch point from the user interface according to the position information; and
enlarging original display contents in the to-be-enlarged display region in accordance with a predetermined enlarging scale and displaying the enlarged contents in a screen content enlarging window.

8. The terminal device according to claim 7, wherein after enlarging the original display contents in the to-be-enlarged display region in accordance with the predetermined enlarging scale and displaying the enlarged contents in the screen content enlarging window, the processor is further configured to perform:
when the terminal device detects that the touch point and the floating icon move simultaneously, enlarging the original display contents in the to-be-enlarged display region currently corresponding to the touch point in accordance with the predetermined enlarging scale and displaying the enlarged contents in the screen content enlarging window in real time.

9. The terminal device according to claim 7, wherein the processor selecting the to-be-enlarged display region corresponding to the touch point from the user interface according to the position information is configured to perform:
determining a central point of the to-be-enlarged display region according to the position information and a preset region radius; and
determining a circular region with a circle center being the central point and within the preset region radius in the user interface as the to-be-enlarged display region corresponding to the touch point.

10. The terminal device according to claim 8, wherein the processor selecting the to-be-enlarged display region corresponding to the touch point from the user interface according to the position information is configured to perform:
determining a central point of the to-be-enlarged display region according to the position information and a preset region radius; and
determining a circular region with a circle center being the central point and within the preset region radius in the user interface as the to-be-enlarged display region corresponding to the touch point.

11. The terminal device according to claim 7, wherein the processor selecting the to-be-enlarged display region corresponding to the touch point from the user interface according to the position information is configured to perform:
determining a circular region with a circle center being the position of the touch point in the user interface and within a preset region radius as the to-be-enlarged display region corresponding to the touch point.

12. The terminal device according to claim 7, wherein before enlarging the original display contents in the to-be-enlarged display region in accordance with the predetermined enlarging scale and displaying the enlarged contents in the screen content enlarging window, the processor is further configured to perform:
hiding or removing the floating icon; and
after enlarging the original display contents in the to-be-enlarged display region in accordance with the predetermined enlarging scale and displaying the enlarged contents in the screen content enlarging window, the processor is further configured to perform:
when the terminal device does not detect the touch point in the floating icon region, removing the screen content enlarging window and redisplaying the floating icon at an initial position in the user interface or at a predetermined position in the user interface.

13. A screen content enlarging method, comprising:
when a terminal device detects a touch point in a floating icon region in a user interface of the terminal device, recording position information of the touch point in the user interface, wherein the floating ion is in a movable state;
selecting a to-be-enlarged display region corresponding to the touch point from the user interface according to the position information; and
enlarging original display contents in the to-be-enlarged display region in accordance with a predetermined enlarging scale and displaying the enlarged contents in a screen content enlarging window.

14. The method according to claim 13, wherein after enlarging the original display contents in the to-be-enlarged display region in accordance with the predetermined enlarging scale and displaying the enlarged contents in the screen content enlarging window, the method further comprises:
when the terminal device detects that the touch point and the floating icon move simultaneously, enlarging the original display contents in the to-be-enlarged display region currently corresponding to the touch point in accordance with the predetermined enlarging scale and displaying the enlarged contents in the screen content enlarging window in real time.

15. The method according to claim 13, wherein selecting the to-be-enlarged display region corresponding to the touch point from the user interface according to the position information comprises:
determining a central point of the to-be-enlarged display region according to the position information and a preset region radius; and
determining a circular region with a circle center being the central point and within the preset region radius in the user interface as the to-be-enlarged display region corresponding to the touch point.

16. The method according to claim 14, wherein selecting the to-be-enlarged display region corresponding to the touch point from the user interface according to the position information comprises:
determining a central point of the to-be-enlarged display region according to the position information and a preset region radius; and
determining a circular region with a circle center being the central point and within the preset region radius in the user interface as the to-be-enlarged display region corresponding to the touch point.

17. The method according to claim 13, wherein selecting the to-be-enlarged display region corresponding to the touch point from the user interface according to the position information comprises:
determining a circular region with a circle center being the position of the touch point in the user interface and within a preset region radius as the to-be-enlarged display region corresponding to the touch point.

18. The method according to claim 13, wherein before enlarging the original display contents in the to-be-enlarged display region in accordance with the predetermined enlarging scale and displaying the enlarged contents in the screen content enlarging window, the method further comprises:
hiding or removing the floating icon; and
after enlarging the original display contents in the to-be-enlarged display region in accordance with the predetermined enlarging scale and displaying the enlarged contents in the screen content enlarging window, the method further comprises:
when the terminal device does not detect the touch point in the floating icon region, removing the screen content enlarging window and redisplaying the floating icon at an initial position in the user interface or at a predetermined position in the user interface.
